(19) United States
(12) Patent Application Publication
(10) Pub. No.: US 2006/0214795 A1
(43) Pub. Date: Sep. 28, 2006

(54) COMPATIBILITY DETERMINATION APPARATUS AND METHOD USING RADIO FREQUENCY IDENTIFICATION SYSTEM

(76) Inventor: HYUN MOON KIM, Icheon-shi Kyungki-do (KR)

Correspondence Address: IPLA P.A., 3580 WILSHIRE BLVD., 17TH FLOOR, LOS ANGELES, CA, 90010, US

(21) Appl. No.: 11/306,622

(22) Filed: Jan. 4, 2006

(30) Foreign Application Priority Data
Mar. 22, 2005 (KR) 10-2005-0023543

(51) Int. Cl. G08B 13/14

(52) U.S. Cl. 340/572.1; 340/10.1

(57) ABSTRACT

A system compatibility determination apparatus and method using a radio frequency identification system is provided. The apparatus includes at least one unit having a radio frequency identification tag having radio frequency identification information; and a main unit equipped with a compatibility determination unit having a compatibility determination table having radio frequency identification information on compatible units, and wireless reading the radio frequency identification information from the radio frequency identification tag, comparing the read radio frequency identification information with the radio frequency identification information of the compatibility determination table, and determining and informing compatibility of the corresponding unit.

### BACKGROUND OF THE INVENTION

1. Field of the Invention

The present invention relates to connection between a plurality of devices, and more particularly, to a system compatibility determination apparatus and method using a radio frequency identification system, for determining and informing whether or not connection is possible between at least two devices having radio frequency identification tags.

2. Description of the Related Art

At present, systems are constructed through connection between a plurality of modularized devices (Hereinafter, referred to as “units”) performing specific functions or connection of the plurality of modularized devices to a main unit. In general, a label is attached to each of the units and expresses an inherent identifier and information of the corresponding unit, and in a system production process, a worker confirms the label attached to the unit, and connects the units therebetween or the units with the main unit.

As described above, in a conventional art, there is a drawback in that, since the worker directly confirms all labels of the units and connects the units, it takes a long time in connecting the units and the worker is much inconvenient.

Further, there is a drawback in that, when the worker erroneously confirms the label and performs the connection, or when the worker is ignorant of change of a use connector and performs the connection, a defect of product can be generated in assembly.

### SUMMARY OF THE INVENTION

Accordingly, the present invention is directed to a system compatibility determination apparatus and method using a radio frequency identification system that substantially overcomes one or more of the limitations and disadvantages of the conventional art.

One object of the present invention is to provide a system compatibility determination apparatus and method using a radio frequency identification system, for determining and informing whether or not connection is possible between at least two devices having radio frequency identification tags

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a compatibility determination apparatus using a radio frequency identification system, the apparatus including: at least one unit having a radio frequency identification tag having radio frequency identification information; and a main unit equipped with a compatibility determination unit having a compatibility determination table having radio frequency identification information on compatible units, and wireless reading the radio frequency identification information from the radio frequency identification tag, comparing the read radio frequency identification information with the radio frequency identification information of the compatibility determination table, and determining and informing compatibility of the corresponding unit.

In another aspect of the present invention, there is provided a compatible determination apparatus using a radio frequency identification system, the apparatus including: at least one unit having a radio frequency identification tag having radio frequency identification information; and a compatibility determination unit having a compatibility determination table having the radio frequency identification information on the units, and radio frequency identification information on units each compatible to the units, and wireless reading the radio frequency identification information from the radio frequency identification tag, comparing the read radio frequency identification information with the radio frequency identification information of the compatibility determination table, and determining and informing compatibility between the units.

In a further another aspect of the present invention, there is provided a compatibility determination method in a compatibility determination apparatus using a radio frequency identification system that includes at least one unit having a radio frequency identification tag storing radio frequency identification information, and a main unit equipped with a compatibility determination unit storing a compatibility determination table having radio frequency identification information on a radio frequency identification reader and compatible units, and including a storage unit for storing the radio frequency identification information read through the radio frequency reader and an input unit for generating a compatibility determination command, the method including the steps of: upon receipt of the compatibility determination command, transmitting a radio frequency identification information request signal; upon receipt of the radio frequency identification information in response to the radio frequency identification request signal, comparing the received radio frequency identification information with the radio frequency identification information of the compatibility determination table, and determining whether or not the units are compatible to the main unit; and if there is an incompatible unit, generating alarm.

In a still further another aspect of the present invention, there is provided a compatibility determination method in a compatibility determination apparatus using a radio frequency identification system that includes at least one unit having a radio frequency identification tag storing radio frequency identification information, and a compatibility determination unit having a compatibility determination table having radio frequency identification information on a radio frequency identification reader and the units and radio frequency identification information on units each compatible to the units, and including a storage unit for storing the radio frequency identification information read through the radio frequency reader and an input unit for generating a compatibility determination command, the method including the steps of: upon receipt of the compatibility determination command, transmitting a radio frequency identification information request signal; upon receipt of the radio frequency identification information in response to the radio frequency identification request signal, comparing the received radio frequency identification information with the radio frequency identification information of the compatibility determination table, and determining compatibility between the units; and if there is an incompatible unit, generating alarm.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a construction of a compatibility determination apparatus using a radio frequency identification system according to the present invention;

FIG. 2 is a flowchart illustrating a compatibility determination method using a radio frequency identification system according to the first embodiment of the present invention;

FIG. 3 is a flowchart illustrating a compatibility determination method using a radio frequency identification system according to the second embodiment of the present invention; and

FIG. 4 is a flowchart illustrating a compatibility determination method using a radio frequency identification system according to the third embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

The present invention provides a system compatibility determination apparatus and method using a radio frequency identification (Hereinafter, referred to as “RFID”) for, when a system including a plurality of units is produced, determining and informing a worker of whether or not connection is possible between the units before the connection of the units.

RFID system includes a device for attaching or inserting a micro-miniature chip having information on an object into the object and wirelessly reading the information, and is applicable to administration of physical distribution and stock, and anti-theft of the object. The object information is, for example, a variety of information such as a manufacture area, a manufacturer, and a function description for the object is to provide information on manufacture, distribution, safekeeping, and consumption of the object. In general, the micro-miniature chip is called “RFID tag”, and the information readable device is called “RFID reader”.

In the present invention, the unit should have the RFID tag storing information such as its manufacture date, manufacture area, manufacturer, brief information on function, and inherent Identification (ID). At least one of the units constituting one system should be provided with a compatibility determination apparatus having the RFID reader being readable the information from the RFID tag, or should be provided with a compatibility determination apparatus having the RFID reader separately from the unit.

A detailed description will be made with reference to the drawings below.

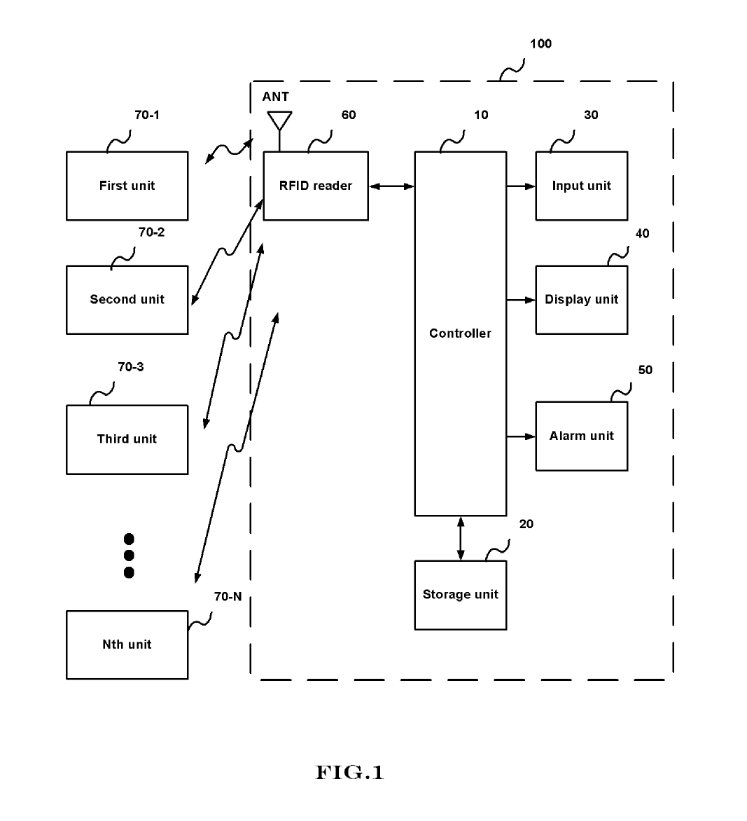

FIG. 1 illustrates a construction of a compatibility determination apparatus using a radio frequency identification system according to the present invention.

Referring to FIG. 1, reference numerals 70-1 to 70-n denote the units, and a reference numeral 100 denotes the compatibility determination apparatus.

Each of the units 70 has the RFID tag storing the information such as its manufacture date, manufacture area, manufacturer, brief information on function, and inherent Identification (ID), and wireless transmits the RFID tag having the information in response to an external signal.

The compatibility determination apparatus 100 includes the RFID reader 60, a controller 10, a storage unit 20, an input unit 30, a display unit 40, and an alarm unit 50.

The controller 10 controls a general operation for determining compatibility between at least two units 70, or between at least one unit and a main unit or system having the compatibility determination apparatus 100.

The storage unit 20 is comprised of a region for storing a control program for compatibility determination; a region for temporarily storing data generated in execution of the control program; a region for storing information included in messages of the units 70 received through the RFID reader 60; a region for, when the compatibility determination apparatus 100 is included in the unit 70 or in the system connecting with the units 70, storing self information; and a region for storing a compatibility determination table having information on mutually connectable, that is, compatible units, or information on the units connectable to the unit including self, that is, the main unit or system.

The input unit 30 is a key input unit providing an interface unit interfacing with a user, and generates a compatibility determination command and a RFID information request command by the user and outputs the user commands to the controller 10.

Further, in case where the inventive compatibility determination apparatus is installed in the main unit or system, the input unit 30 can be constructed to generate and output the compatibility determination command at a constant period.

The display unit 40 displays RFID information and a result of compatibility determination under the control of the controller 10.

The alarm unit 50 generates an alarm under the control of the controller 10 in case where information on the unit 70 not satisfying compatibility is detected.

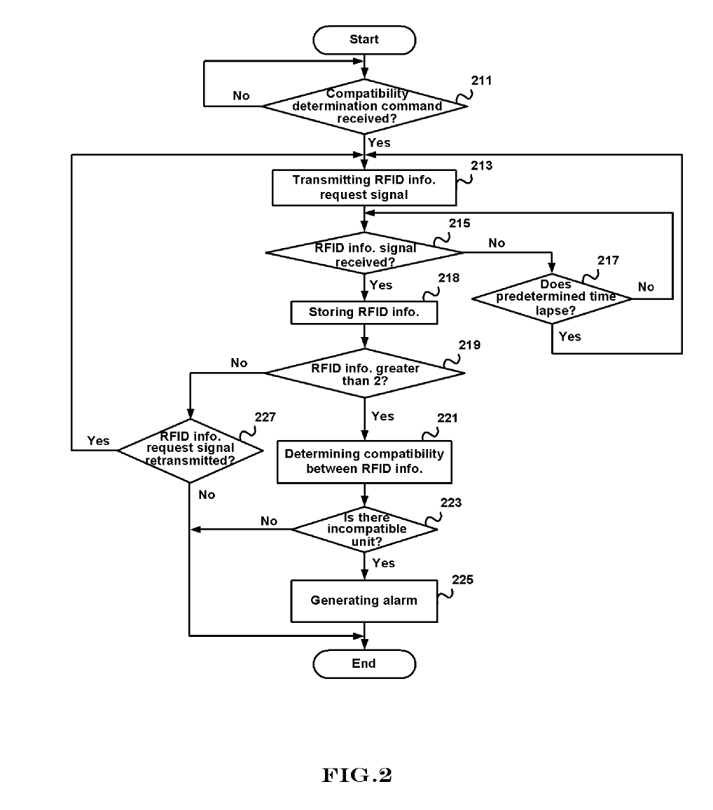

FIG. 2 is a flowchart illustrating a compatibility determination method using a radio frequency identification system according to the first embodiment of the present invention, and illustrates a method for, in a separate compatibility determination apparatus, receiving the information of the plurality of units 70 at one time and determining the compatibility or not. A description will be made with reference to FIGS. 1 and 2 below.

First, the controller 10 determines whether or not to receive the compatibility determination command from the input unit 30 in Step 211. If it is determined to receive the compatibility determination command in the Step 211, the controller 10 controls the RFID reader 60 to transmit a RFID information request signal in Step 213. The RFID information request signal is transmitted to all the plurality of units 70 having the RFID tag within a predetermined distance. Each of the units 70 wireless transmits its own RFID information in response to the RFID information request signal.

After the Step 213, in Step 215, the controller 10 determines whether or not to receive the RFID information from the units 70 through the RFID reader 60. If it is determined to receive the RFID information in the Step 215, Step 218 is performed, and if it is determined not to receive the RFID information for a predetermined time in Step 217, the Step 213 is performed to retransmit the RFID information request signal.

In the Step 218, the controller 10 stores the received RFID information in the storage unit 20 and, in Step 219, determines whether or not the RFID information is two or more pieces. This is because at least two units 70 should be provided so as to determine the compatibility.

If it is determined to receive only one piece of the RFID information as the determination result of the Step 219, in Step 227, the controller 10 determines whether or not to receive the compatibility determination command from the input unit 30, and determines whether or not there occurs a RFID information retransmission request. If the RFID information retransmission request occurs in the Step 227, the controller 10 repeatedly performs the Step 213 and its subsequent steps.

However, if the received RFID information is two or more pieces in the Step 219, in Step 221, the controller 10 compares the received RFID information with compatibility information between the units stored in the storage unit 20, and determines whether or not the compatibility between the units 70 receiving the RFID information is performed.

After the Step 221, the controller 10 determines whether or not there is an incompatible unit in Step 223. If it is determined to be the incompatible unit, in Step 225, the controller 10 generates the alarm such as an alarm sound through the alarm unit 50, and displays the RFID information of the incompatible unit on the display unit 40.

In an exemplary case where a first unit 70-1 is the main unit, a second unit 70-2 is compatible to the first unit 70-1, and a third unit 70-3 is incompatible to the first unit 70-1, the controller 10 receives and stores the RFID information of the first unit 70-1, the second unit 70-2, and the third unit 70-3 through the RFID reader 60. The controller 10 compares an inherent identifier of the RFID information of each unit with inherent identifier information on the units compatible with the first unit 70-1 previously stored in the storage unit 20, and determines the compatibility. In other words, the inherent identifier information on the third unit 70-3 is not stored in the storage unit 20 and therefore, the controller 10 decides that the third unit 70-3 is the incompatible unit, alarms through the alarm unit 50, and displays the RFID information on the third unit 70-3 on the display unit 40.

In the above, the inherent identifier of the unit is used but an amount of data can be increased and therefore, the same function code can be allocated to the units executing the same function and the compatibility determination can be performed by the function code. In this case, the storage unit 20 should have information on compatible codes at each unit, and even the RFID tag should have a code for the function of the corresponding unit.

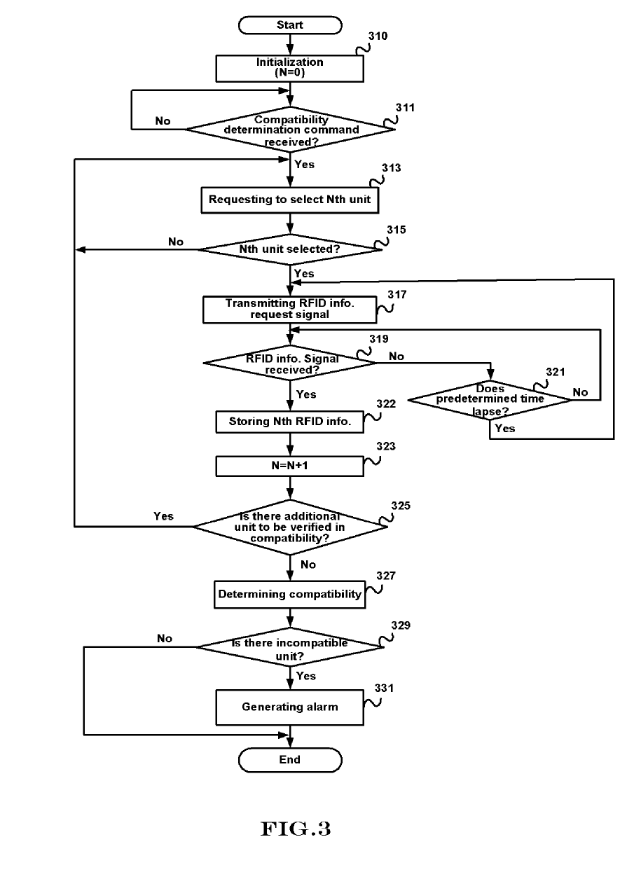

FIG. 3 is a flowchart illustrating a compatibility determination method using a radio frequency identification system according to the second embodiment of the present invention, and illustrates a method for, in a separate compatibility determination apparatus, receiving the information of the plurality of units 70 at one time and determining the compatibility or not. A description will be made with reference to FIGS. 1 and 3 below.

In Step 310, the controller 10 initializes a variable (N) in order to sequentially index and store the received RFID information. After the initialization of the variable, in Step 311, the controller 10 determines whether or not to receive the compatibility determination command from the input unit 30. If it is determined to receive the compatibility determination command in the Step 311, in the Step 313, the controller 10 displays a message of requesting to select an Nth unit on the display unit 40. After the request, the controller 10 determines whether or not to select the Nth unit in Step 315. If it is determined to select the Nth unit, in Step 317, the controller 10 transmits a RFID information request signal. At this time, if there is the plurality of units 70 around the Nth unit, a wireless signal power of the RFID information request signal should be controlled to allow the RFID information to be read only from the short-distance unit 70. The controlling of the wireless signal power is well known to those skilled in the art and therefore, its description will be omitted. After the transmitting of the RFID information request signal, in Step 319, the controller 10 determines whether or not to receive the RFID information from the corresponding unit 70. In Step 321, the controller 10 determines for a predetermined time whether or not to receive the RFID information signal and, upon lapse of the predetermined time, the controller 10 retransmits the RFID information request signal in the Step 317.

If it is determined to receive the RFID information signal in the Step 319, the controller 10 stores the RFID information signal in the storage unit 20 in the Step 322, and increases the variable N by 1 in Step 323. After the Step 323, the controller 10 determines whether or not there is an additional unit to be verified in compatibility in Step 325. If it is determined to be the additional unit in the Step 325, the controller 10 repeatedly performs the Step 313 and its subsequent steps. Accordingly, the “N” should be at least two or more. If it is determined not to be the additional unit in the Step 325, the controller 10 performs a comparison with the information of the compatibility determination table storing the information on the units compatible with the units 70 in Step 327, and determines whether or not there is the incompatible units in Step 329. If it is determined to be the incompatible unit in the Step 329, the controller 10 generates the alarm through the alarm unit 50 in Step 313, and displays the RFID information on the incompatible unit on the display unit 40.

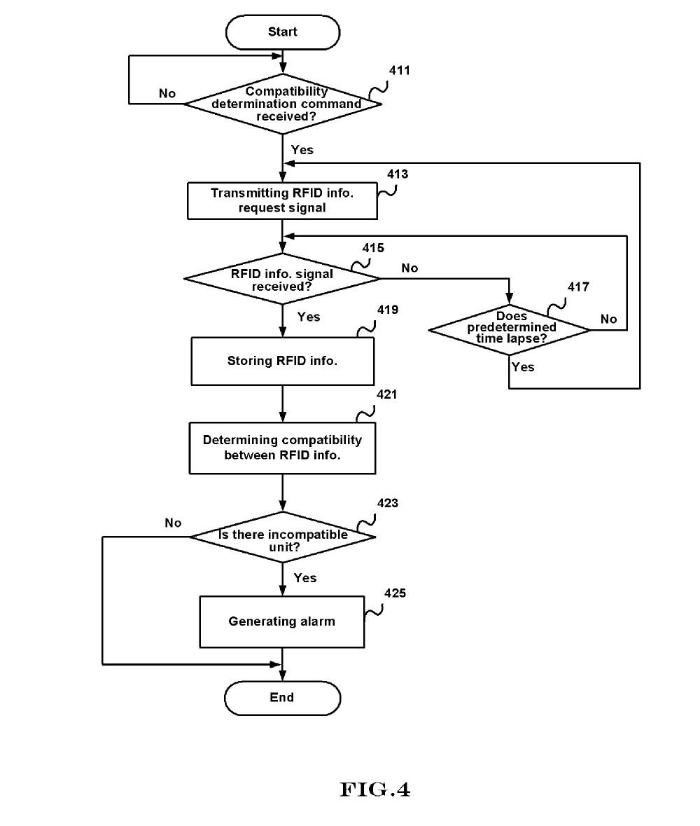

FIG. 4 is a flowchart illustrating a compatibility determination method using a radio frequency identification system according to the third embodiment of the present invention, and illustrates a case where the inventive compatibility determination apparatus is included in a specific unit or system.

The method according to the third embodiment performs a similar procedure with the first embodiment of the present invention. The third embodiment is different from the first embodiment in that it is determined only whether or not there is provided the compatibility between the unit or system including the inventive compatibility determination apparatus and the unit to be connected with the unit or system and therefore, only the Steps 219 and 227 of the first embodiment of FIG. 2 will be omitted. Further, in the third embodiment, a compatibility determination command of Step 411 can be also generated by the input unit such as the key input unit but it can be difficult to separately construct the input unit such as the key input unit on an aspect of characteristics of the unit and the system and therefore, the present invention can be constructed to generate the compatibility determination command at a constant period by the timer.

In an application example of the third embodiment, it will be applicable to a system independently including a radio unit, a tape player unit, and compact disk (CD) and digital video disk (DVD) player units, and including an audio/video (AV) head unit (or main unit) for mounting the units. In other words, the radio unit, the tape player unit, and the CD and DVD player units can include the RFID tag, and the AV head unit can include the RFID reader 60, to be used for determining the units mountable on the AV head unit.

As described above, the present invention has an advantage in that, in the system having the same external structure, erroneous insertion can be prevented and therefore, each unit can be prevented from malfunctioning, thereby preventing economic loss.

Further, the present invention has an advantage in that when a change on the system is required, it has only to modify or add only corresponding information of the compatibility determination table of the compatibility determination apparatus and therefore, it can be simply determined whether or not there is the compatibility.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A compatibility determination apparatus using a radio frequency identification system, the apparatus comprising:
at least one unit having a radio frequency identification tag having radio frequency identification information; and
a main unit equipped with a compatibility determination unit having a compatibility determination table having radio frequency identification information on compatible units, and wireless reading the radio frequency identification information from the radio frequency identification tag, comparing the read radio frequency identification information with the radio frequency identification information of the compatibility determination table, and determining and informing compatibility of the corresponding unit.

2. The apparatus according to claim 1, wherein the compatibility determination unit comprises:
a radio frequency identification reader for wireless reading the radio frequency identification information from the radio frequency identification tags of the units;
a storage unit for storing the compatible determination table having the radio frequency identification information on the compatible units, and storing the radio frequency identification information read through the radio frequency identification reader; and
a controller for comparing the read radio frequency identification information with the radio frequency identification information stored in the compatible determination table, and determining whether or not the units each corresponding to the read radio frequency identification information are compatible.

3. The apparatus according to claim 2, further comprising an alarm unit for, when it is determined as the determination result to be an incompatible unit, generating alarm under the control of the controller.

4. The apparatus according to claim 2, further comprising a display unit for, when it is determined to be an incompatible unit, displaying radio frequency identification information read from the incompatible unit.

5. The apparatus according to claim 3, further comprising a display unit for, when it is determined to be the incompatible unit, displaying radio frequency identification information read from the incompatible unit.

6. The apparatus according to any one of claims 1, wherein the radio frequency identification information is an inherent identifier of each of the units.

7. The apparatus according to any one of claims 2, wherein the radio frequency identification information is an inherent identifier of each of the units.

8. The apparatus according to any one of claims 3, wherein the radio frequency identification information is an inherent identifier of each of the units.

9. The apparatus according to any one of claims 4, wherein the radio frequency identification information is an inherent identifier of each of the units.

10. The apparatus according to any one of claims 5, wherein the radio frequency identification information is an inherent identifier of each of the units.

11. The apparatus according to any one of claims 1, wherein the radio frequency identification information is a function code representing a function.

12. The apparatus according to any one of claims 2, wherein the radio frequency identification information is a function code representing a function.

13. The apparatus according to any one of claims 3, wherein the radio frequency identification information is a function code representing a function.

14. The apparatus according to any one of claims 4, wherein the radio frequency identification information is a function code representing a function.

15. The apparatus according to any one of claims 5, wherein the radio frequency identification information is a function code representing a function.

16. A compatible determination apparatus using a radio frequency identification system, the apparatus comprising:
at least one unit having a radio frequency identification tag having radio frequency identification information; and
a compatibility determination unit having a compatibility determination table having the radio frequency identification information on the units, and radio frequency identification information on units each compatible to the units, and wireless reading the radio frequency identification information from the radio frequency identification tag, comparing the read radio frequency identification information with the radio frequency identification information of the compatibility determination table, and determining and informing compatibility between the units.

17. The apparatus according to claim 16, wherein the compatibility determination unit comprises:
a radio frequency identification reader for wireless reading the radio frequency identification information from the radio frequency identification tags of the units;
a storage unit for storing the compatible determination table having the radio frequency identification information on the units, and the radio frequency identification information on the units each compatible to the units, and storing the radio frequency identification information read through the radio frequency identification reader; and
a controller for comparing the read radio frequency identification information with the radio frequency identification information stored in the compatible determination table, and determining whether or not the units each corresponding to the read radio frequency identification information is compatible.

18. The apparatus according to claim 17, further comprising an alarm unit for, when it is determined as the determination result to be an incompatible unit, generating alarm under the control of the controller.

19. The apparatus according to claim 17, further comprising a display unit for, when it is determined to be an incompatible unit, displaying radio frequency identification information read from the incompatible unit.

20. The apparatus according to claim 18, further comprising a display unit for, when it is determined to be the incompatible unit, displaying radio frequency identification information read from the incompatible unit.

21. The apparatus according to any one of claims 16, wherein the radio frequency identification information is an inherent identifier of each of the units.

22. The apparatus according to any one of claims 17, wherein the radio frequency identification information is an inherent identifier of each of the units.

23. The apparatus according to any one of claims 18, wherein the radio frequency identification information is an inherent identifier of each of the units.

24. The apparatus according to any one of claims 19, wherein the radio frequency identification information is an inherent identifier of each of the units.

25. The apparatus according to any one of claims 20, wherein the radio frequency identification information is an inherent identifier of each of the units.

26. The apparatus according to any one of claims 16, wherein the radio frequency identification information is a function code representing a function.

27. The apparatus according to any one of claims 17, wherein the radio frequency identification information is a function code representing a function.

28. The apparatus according to any one of claims 18, wherein the radio frequency identification information is a function code representing a function.

29. The apparatus according to any one of claims 19, wherein the radio frequency identification information is a function code representing a function.

30. The apparatus according to any one of claims 20, wherein the radio frequency identification information is a function code representing a function.

31. A compatibility determination method in a compatibility determination apparatus using a radio frequency identification system that includes at least one unit having a radio frequency identification tag storing radio frequency identification information, and a main unit equipped with a compatibility determination unit storing a compatibility determination table having radio frequency identification information on a radio frequency identification reader and compatible units, and including a storage unit for storing the radio frequency identification information read through the radio frequency reader and an input unit for generating a compatibility determination command, the method comprising the steps of:
upon receipt of the compatibility determination command, transmitting a radio frequency identification information request signal;
upon receipt of the radio frequency identification information in response to the radio frequency identification request signal, comparing the received radio frequency identification information with the radio frequency identification information of the compatibility determination table, and determining whether or not the units are compatible to the main unit; and
if there is an incompatible unit, generating alarm.

32. The method according to claim 31, wherein radio frequency identification information on the incompatible unit is displayed on a display unit.

33. The method according to claim 31, wherein the radio frequency identification information is an inherent identifier of each of the units.

34. The method according to claim 31, wherein the radio frequency identification information is a function code representing a function.

35. A compatibility determination method in a compatibility determination apparatus using a radio frequency identification system that includes at least one unit having a radio frequency identification tag storing radio frequency identification information, and a compatibility determination unit having a compatibility determination table having radio frequency identification information on a radio frequency identification reader and the units and radio frequency identification information on units each compatible to the units, and including a storage unit for storing the radio frequency identification information read through the radio frequency reader and an input unit for generating a compatibility determination command, the method comprising the steps of:
upon receipt of the compatibility determination command, transmitting a radio frequency identification information request signal;
upon receipt of the radio frequency identification information in response to the radio frequency identification request signal, comparing the received radio frequency identification information with the radio frequency identification information of the compatibility determination table, and determining compatibility between the units; and
if there is an incompatible unit, generating alarm.
